(19) United States
(12) Patent Application Publication
(10) Pub. No.: US 2013/0276722 A1
(43) Pub. Date: Oct. 24, 2013

(54) Thermal Insulators for Providing a Thermal Break Between the Body and Flange Assembly of a Gas Water Heater Control

(71) Applicants: John M. Bronson, St. Louis, MO (US); Jeffrey N. Arensmeier, Fenton, MO (US)

(72) Inventors: John M. Bronson, St. Louis, MO (US); Jeffrey N. Arensmeier, Fenton, MO (US)

(73) Assignee: EMERSON ELECTRIC CO., St. Louis, MO (US)

(21) Appl. No.: 13/454,612

(22) Filed: Apr. 24, 2012

(51) Int. Cl. F24H 9/02; F24H 1/18; B23P 6/00; F24H 9/20

(52) U.S. Cl. 122/19.2; 137/375; 220/592.22; 122/14.2; 29/890.031

(57) ABSTRACT

According to various aspects, exemplary embodiments are disclosed in which thermal insulation is used to provide a thermal break and/or thermally insulative barrier generally between a body and flange assembly of a gas water heater control. An exemplary embodiment of a valve assembly for a water heater generally includes a flange, a body, and a thermal insulator. The thermal insulator is configured for placement generally between the body and the flange. The thermal insulator has a lower thermal conductivity than the flange and the body. The thermal insulator is operable for inhibiting heat loss from within the storage tank through the valve assembly.

### FIELD

The present disclosure relates to apparatus and methods in which thermal insulation is used to provide a thermal break and/or thermally insulative barrier between the body and flange assembly of a gas water heater control.

### BACKGROUND

This section provides background information related to the present disclosure which is not necessarily prior art.

Storage water heaters may be utilized domestically and industrially in various applications. Domestically, a storage water heater is used for generation of hot water that may be used for bathing, cleaning, cooking, space heating, and the like.

A conventional gas fired water heater includes a water storage tank and gas fired burner assembly for heating water within the tank. In operation, combustion gases generated by the firing of the burner assembly may be directed upwardly through a flue pipe via a hood. The combustion gases serve to transfer heat to the water contained within the storage tank. The top of the water heater may include suitable fittings for connection to a supply of water and a water distribution system with a water inlet provided with a dip tube, which serves to direct the inflow of cold water to the bottom of the tank.

Additionally, the water heater includes a control, controller, or control system for controlling the supply of gas to the burner assembly in response to the sensed temperature of the water within the tank. For example, if the water temperature reaches a preset temperature, the control will close the valve supplying the fuel (e.g., natural gas, propane, etc.) to the burner assembly. Closing the valve discontinues the supply of fuel to the burner assembly, which shuts down or turns off the burner assembly.

A typical gas valve used on conventional, storage-type gas water heaters includes an aluminum body, a brass flange, and a copper tube. The copper tube is attached (e.g., usually threaded, etc.) to the brass flange. The brass flange is attached (e.g., usually with screws, etc.) to the body of the gas valve. The brass flange is threaded to mate and provide a leak-tight seal with a threaded hole in the water heater tank. The copper tube extends several inches into the water tank and serves as the temperature sensing device for the system. The copper tube expands and contracts (in length) in response to changes in water temperature. When hot water is drawn from the tank, cold water enters the tank. When cold water hits the copper tube, it contracts. This movement is what actuates the gas valve by pushing on a rod. The rod pushes on a lever, which opens the valve via a series of springs. As the water heats up, this process is reversed and the valve shuts off. This type of system may be known as or referred to as “Rod & Tube” system.

By way of example, FIGS. 1 and 6 illustrate conventional mechanical and electronic water heater controls 100, 200, respectively, that may be used with a water heater as disclosed herein. As shown in FIG. 1, the mechanical control 100 includes a body 104 (e.g., aluminum, etc.), a flange 108 (e.g., brass, etc.), a tube 112 (e.g., copper, etc.), and a gas control knob 116 for adjusting or setting the temperature for the water in the tank.

The electronic control 200 shown in FIG. 6 includes a body (e.g., aluminum, etc.), a flange 208 (e.g., brass, etc.), and a tube 212 (e.g., copper, etc.). The flange 208 is connected to a bracket 204, which, in turn, is connected to the body. The control 200 also includes a user interface (e.g., display screen, buttons, etc.) for adjusting or setting the temperature for the water in the tank.

### SUMMARY

This section provides a general summary of the disclosure, and is not a comprehensive disclosure of its full scope or all of its features.

According to various aspects, exemplary embodiments are disclosed in which thermal insulation is used to provide a thermal break and/or thermally insulative barrier generally between a body and flange assembly of a gas water heater control. An exemplary embodiment of a valve assembly for a water heater generally includes a flange, a body, and a thermal insulator. The thermal insulator is configured for placement generally between the body and the flange. The thermal insulator has a lower thermal conductivity than the flange and the body. The thermal insulator is operable for inhibiting heat loss from within the storage tank through the valve assembly.

Another exemplary embodiment includes a valve assembly for adjusting fuel flow in a fuel-fired water heater having a storage tank. In this example, the valve assembly generally includes a thermal insulator and a first component configured to be coupled to the storage tank. A second component is coupled to the first component with the thermal insulator generally between the first and second components. A third component is coupled to the first component. The third component is configured to extend at least partially into the storage tank for sensing temperature of water within the storage tank when the first component is coupled to the storage tank. The thermal insulator has a lower thermal conductivity than the first, second, and third components for inhibiting heat loss from within the water storage tank through the valve assembly.

Also disclosed are exemplary embodiments of methods for inhibiting heat loss from a storage tank of a water heater through a valve assembly of the water heater. In an exemplary embodiment, a method generally includes positioning a thermal insulator generally between a body and flange of the valve assembly. The thermal insulator has a thermal conductivity less than a thermal conductivity of the flange and the body.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a conventional mechanical water heater control for controlling fuel flow in a fuel fired water heater;

FIG. 2 is an exploded perspective view illustrating an exemplary embodiment of a thermal insulator positioned between the body and flange assembly of the mechanical water heater control and shown in FIG. 1 according to the present disclosure;

FIG. 3 illustrates the mechanical water heater control shown in FIG. 2 coupled to a hot water tank, and also showing the thermal insulator between the body and the flange assembly of the mechanical water heater control;

FIG. 4 is a perspective view of the thermal insulator show in FIG. 2;

FIG. 5 is a back view of the thermal insulator shown in FIG. 2;

FIG. 6 is a perspective view of a conventional electronic water heater control for controlling fuel flow in a fuel fired water heater;

FIG. 7 is an exploded perspective view illustrating another exemplary embodiment of a thermal insulator positioned between the body and flange assembly of the electronic water heater control shown in FIG. 6 according to the present disclosure;

FIG. 8 illustrates the electronic water heater control shown in FIG. 7 coupled to a hot water tank, and also showing the thermal insulator between the body and the flange assembly of the electronic water heater control;

FIG. 9 is a front view of the thermal insulator shown in FIG. 7;

FIG. 10 is a side view of the thermal insulator shown in FIG. 9;

FIG. 11 is a front view of another exemplary embodiment of a thermal insulator or gasket that may be positioned between a body and flange assembly of a water heater control;

FIG. 12 is an exemplary line graph illustrating heat loss in British thermal units per hour versus flange temperature in degrees Fahrenheit for a flange with and without the thermal insulator or gasket shown in FIG. 11;

FIG. 13 is an exemplary line graph illustrating percentage of heat loss versus flange temperature in degrees Fahrenheit for a control having the thermal insulator or gasket shown in FIG. 11 installed between the body and flange assembly of the control; and

FIG. 14 is an exemplary bar graph showing heat dissipation in British thermal units per hour per degrees Fahrenheit at a gas valve flange with and without the thermal insulator or gasket shown in FIG. 11 between the valve and flange and with and without thermally insulative washers on the flange screws.

### DETAILED DESCRIPTION

Example embodiments will now be described more fully with reference to the accompanying drawings.

In a conventional, storage-type gas water heater, the water tank may be thermally insulated to reduce heat loss to the surrounding area. But the inventors hereof have recognized that the gas valve is a weakness in this thermal insulation scheme given that heat may be lost through the gas valve. This is because the typical gas valve has an aluminum body that is thermally linked (e.g., via a thermally efficient heat path defined by thermally conductive components, etc.) to the hot water in the storage tank directly through a brass flange and copper tube of a flange assembly. The flange assembly may be part of a mechanical or electronic control that is operable for controlling fuel flow in the water heater system.

The copper tube is attached (e.g., usually threaded, etc.) to the brass flange. The brass flange is attached (e.g., usually with screws, etc.) to the body of the gas valve. The brass flange is threaded to mate and provide a leak-tight seal with a threaded hole in the water heater tank. The copper tube extends into the water tank and serves as the temperature sensing device for the system.

Accordingly, even though the gas valve body is externally located or outside the storage tank, there is a thermally conductive pathway from the hot water inside the tank to the gas valve body via the copper tube and flange. This causes the gas valve body to act as a heat sink and conduct heat out of the tank, which reduces efficiency and wastes energy. Also, the gas valve body being cooler than the hot water and being connected to the flange reduces the temperature of the outboard portion of the tube, which, in turn, reduces the thermal sensitivity of the system resulting in increased differentials. Additionally, the connected thermal mass of the gas valve body causes the temperature of the outboard portion of the tube to lag that of the water in time additionally increasing differential.

After recognizing the above drawbacks, the inventors hereof have disclosed exemplary embodiments in which thermal insulation (e.g., one or more thermal insulating materials or insulators, etc.) provides, creates, and/or defines a thermal break or thermally insulative barrier in or along the thermally conductive heat path that is normally defined from the hot water in the storage tank to the gas valve body via the tube (which extends into the hot water) and the flange (which is connected to both the tube and gas valve body). This thermal break or barrier, in turn, reduces heat transfer from the water storage tank via the flange assembly (which includes the tube and flange) to the gas valve body, and ultimately to the atmosphere. This helps increase the rated efficiency of the water heater in standby mode and inhibits heat loss from the hot water within the water heater storage tank through the valve assembly and/or control.

In exemplary embodiments, thermal insulation (e.g., one or more thermal insulating materials or insulators, etc.) is provided generally between or at a connection of first and second components, members, or portions of a gas valve assembly (e.g., a rod and tube valve type system, etc.). In such exemplary embodiments, the thermal insulation, the connection, and the first and second components of the gas valve assembly are located external to the storage tank. But the first component (e.g., flange, etc.) is coupled (e.g., threaded, etc.) to a third component (e.g., thermistor tube or other temperature sensing device, etc.) that extends into the hot water in the tank for sensing the temperature of the water. Accordingly, the thermal insulation thus provides a thermal break or thermally insulative barrier/impediment in or along the thermally conductive heat path that would otherwise exist from the hot water to the second component (e.g., gas valve body, etc.).

Exemplary embodiments are also disclosed of methods for stopping or inhibiting heat from a hot water tank from being lost through a valve assembly/control by providing, creating, and/or defining a thermal break or thermally insulative barrier in or along the thermally conductive heat path from the hot water in the storage tank to a body or other external portion of the valve assembly/control. Examples are disclosed herein in which thermal insulation (e.g., one or more thermal insulating materials, insulators, thermal isolation gaskets, etc.) is provided generally between first and second components, members, or portions of a gas valve assembly. In an exemplary embodiment, a method generally includes positioning a thermal insulator generally between first and second components of a gas valve assembly that are located external to the storage tank. The second component (e.g., flange, etc.) is thermally coupled (e.g., threaded, etc.) to at least one other component (e.g., tube, etc.) that extends into the hot water in the tank. The method may also include coupling (e.g., mechanically fastening, etc.) the second component to the first component (e.g., a body of the gas valve assembly, etc.) such that the thermal insulator is between the portions of the first and second components coupled together. By way of example, coupling the first and second components may include using one or more mechanical fasteners that are inserted through aligned fastener holes in the first and second components and the thermal insulator. By way of further example, the second component may be coupled to a fourth component, which, in turn, is coupled to the first component.

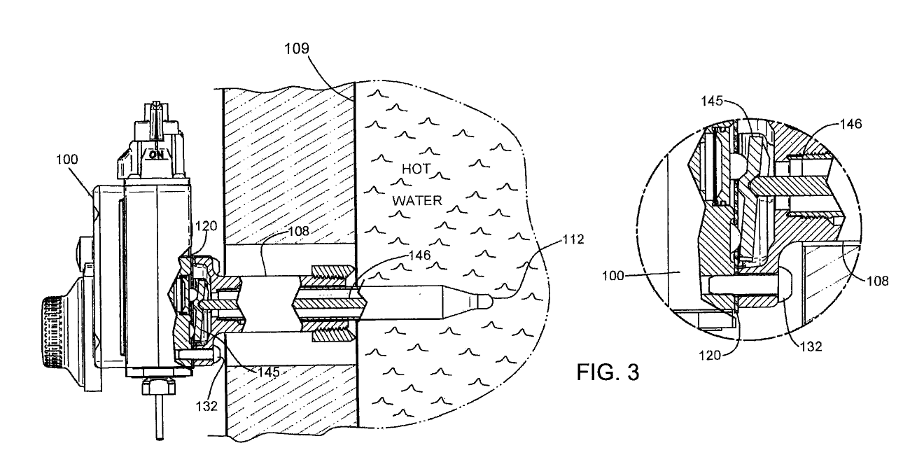

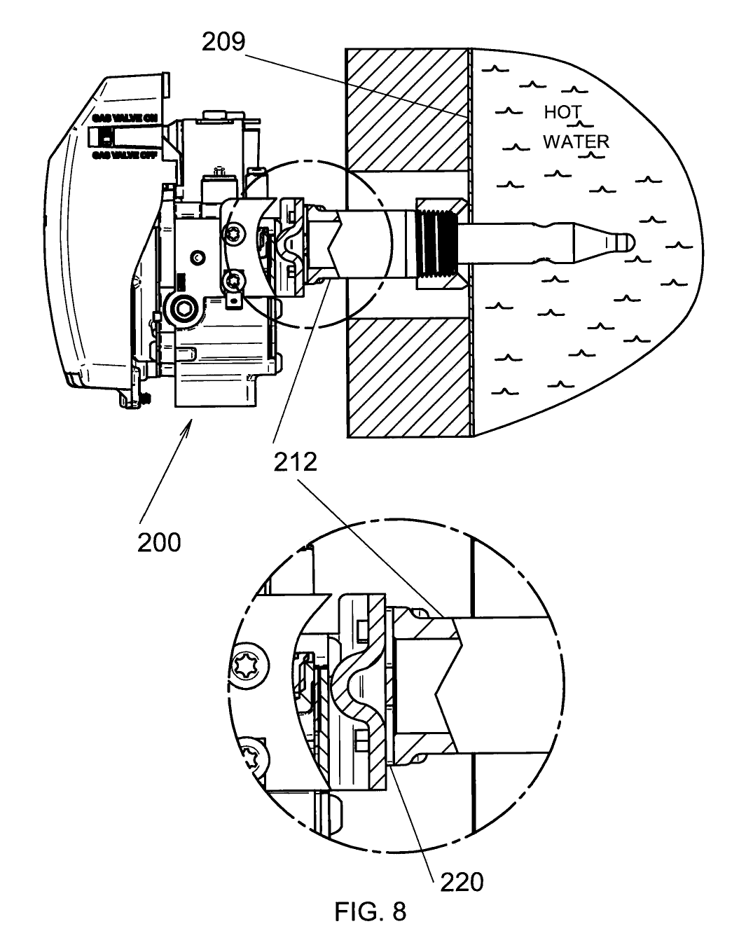

In an exemplary embodiment, a valve assembly for a fuel fired water heater includes a flange, a body, and thermal insulation (e.g., one or more thermal insulating materials or insulators, etc.) generally between the flange and the body. The flange may have a first end portion coupled (e.g., mechanically fastened, etc.) directly or indirectly to the body. For example, the first end portion of the flange may be coupled to a bracket, which bracket is coupled to the body. In other embodiments, the flange may be coupled directly to the body without an intervening bracket. The flange may have a second end portion configured (e.g., threaded, etc.) to mate and provide a leak-tight seal with a hole (e.g., threaded, etc.) in a water heater tank (see, e.g., FIGS. 3 and 8). The valve assembly may also include a tube that extends into the water tank, which serves as a temperature sensing device as disclosed herein. The tube may be coupled (e.g., threaded, etc.) to the flange. An electronic or mechanical control, controller, or control system may be coupled to or included with the valve assembly for controlling the supply of gas to the burner assembly via the valve assembly in response to the sensed temperature of the water within the tank. The thermal insulation provides, creates, and/or defines a thermal break or thermally insulative barrier in or along the thermally conductive heat path that is normally defined from the hot water in the storage tank to the gas valve body via the tube (which extends into the hot water) and the flange (which is coupled to both the tube and gas valve body).

The particular configuration (e.g., shape, size, materials, etc.) of the thermal insulation may vary depending, for example, on the particular installation, such as the type of control (e.g., mechanical or electronic, etc.) and/or configuration of the storage tank (e.g., capacity, etc.). For example, thermal insulators used with mechanical water heater controls may need to have certain properties (e.g., rigidity, stiffness, minimum Young's modulus of 200000, etc.) different than that needed for thermal insulators used with electronic water heater controls.

In an exemplary embodiment, a thermal insulator for a mechanical water heater control is made from stainless steel (e.g., plate made of type 301 stainless steel full hard having a thickness of about 0.01 inches or more, etc.) or other suitable thermally insulating materials that are sufficiently rigid and stiff to meet the rigidity and stiffness requirements of the actuator system in a mechanical control. In this example, the stainless steel insulator (e.g., plate, etc.) may be configured (e.g., shaped, sized, provided with fastener holes and other openings, etc.) for placement between (e.g., mechanically fastened between, etc.) a brass flange and aluminum body of a gas valve of a mechanical control. Stainless steel is a poor conductor of heat and has a lower thermal conductivity than many other metals, including aluminum, brass, and copper. Thus, the stainless steel insulator may serve as a thermal break or barrier between the more thermally conductive brass flange and aluminum body of a mechanical control, to thereby reduce the amount of heat being conducted into the body of the gas valve.

In another exemplary embodiment, a thermal insulator for an electronic water heater control is made of a circuit board material (e.g., flame retardant 4 (FR-4) circuit board material, etc.), G-10 phenolic sheet material, or other suitable thermally insulating materials. By way of example only, a thermal insulator may be formed from a FR-4, G-10 phenolic sheet, or similar material having a thickness of about 0.020 inches (e.g., about 0.021 inches, etc.).

For an electronic control, less rigid/more flexible thermal insulators may be used because the same level of rigidity is not needed for an electronic control as a mechanical control. In this example, the thermal insulator may be configured (e.g., shaped, sized, provided with fastener holes and other openings, etc.) for placement between (e.g., mechanically fastened between, etc.) a brass flange and aluminum body of a gas valve of an electronic control. FR-4 circuit board material is a poor conductor of heat and has a lower thermal conductivity than many metals, including aluminum, brass, and copper. Thus, the FR-4 insulator may serve as a thermal break or barrier between the more thermally conductive brass flange and aluminum body of an electronic control, to thereby reduce the amount of heat being conducted into the body of the gas valve.

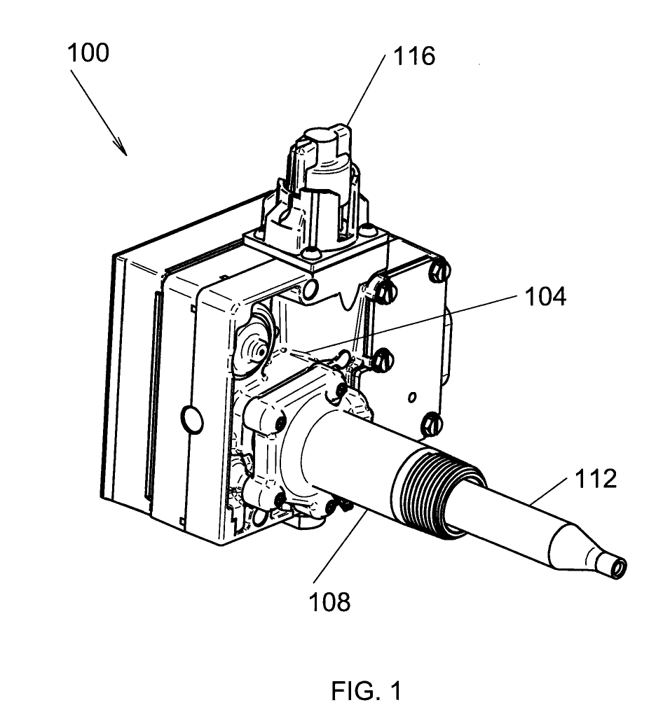

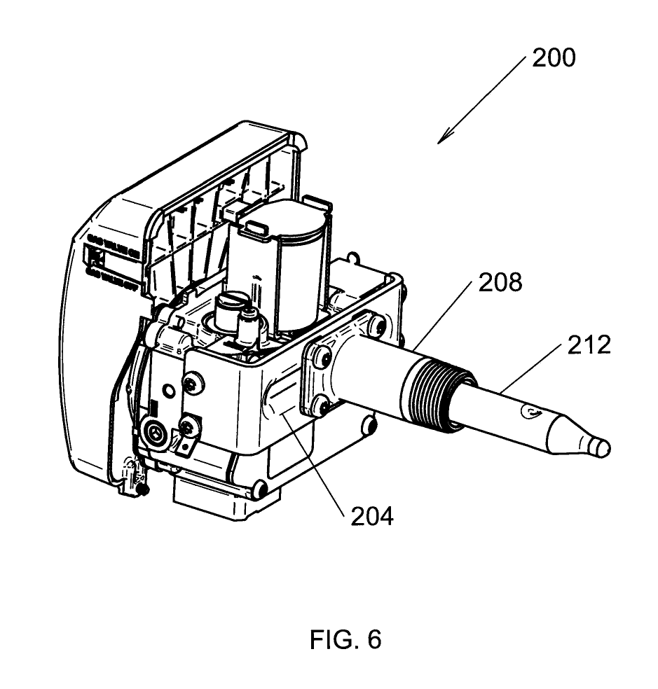

Thermal insulation may be provided to a wide range of valve assemblies, controls, and controllers for water heaters in accordance with the present disclosure. For example, thermal insulation may be provided to a controller such as the mechanical water heater control 100 shown in FIGS. 1 through 3, the electronic water heater control 200 shown in FIGS. 6 through 8, a White Rodgers 37C73U and/or 37C72U water heater natural gas valve control (e.g., 37C73U-836 hot water tank valve, etc.), a controller disclosed in U.S. Patent Application Publication 2009/0101085, a gas valve device disclosed in U.S. Pat. No. 4,205,972, etc. The entire disclosures of the above published patent application and issued patent are incorporated herein by reference.

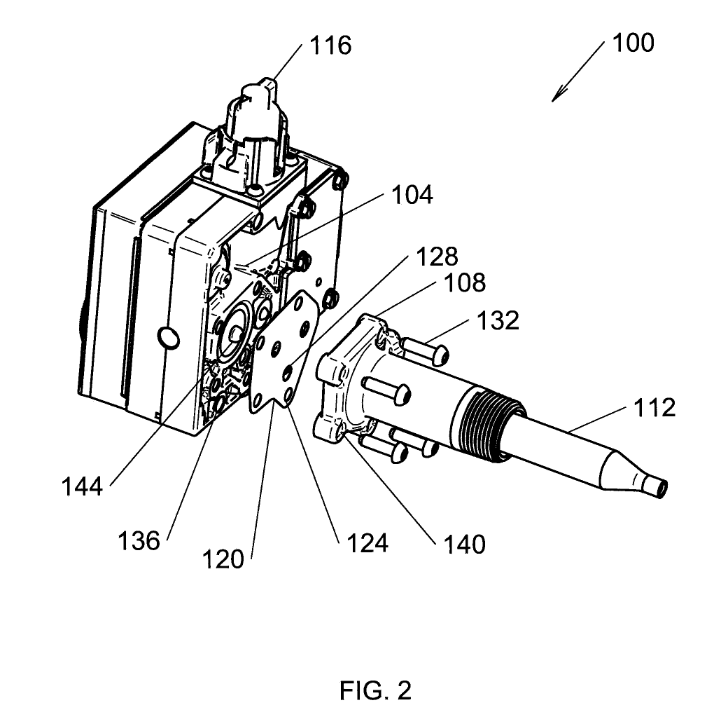

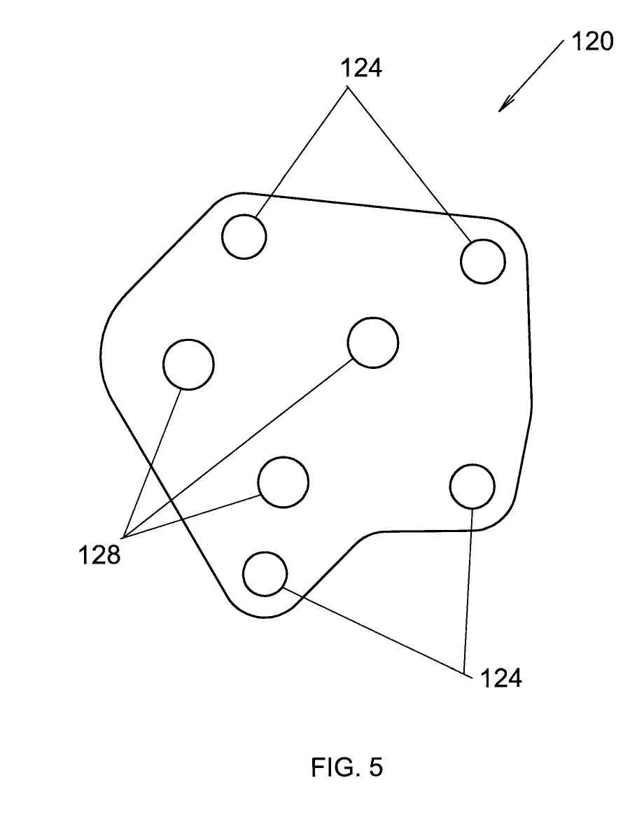

FIGS. 2 through 5 illustrate an exemplary embodiment of a thermal insulator 120 embodying one or more aspects of the present disclosure. As shown in FIGS. 2 and 3, the thermal insulator 120 is configured for placement between the body 104 and flange 108 of the mechanical water heater control 100. FIG. 3 illustrates the mechanical water heater control 100 coupled to a wall 109 of a hot water tank and with the tube 112 extending into the hot water.

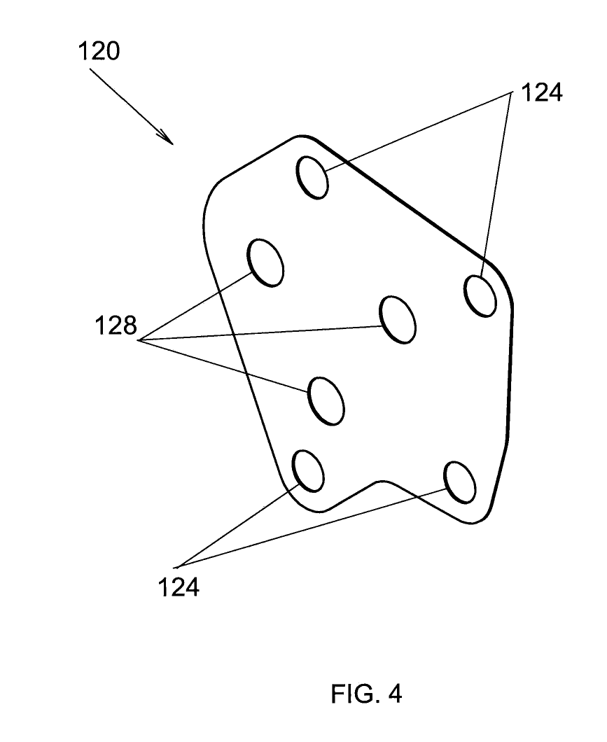

The thermal insulator 120 is shaped (e.g., six sided polygon, etc.), sized, and provided with fastener holes 124 (FIG. 4) such that the thermal insulator 120 may be mechanically fastened with bolts 132 (FIGS. 2 and 3) or other suitable fasteners between the body 104 and flange 108 of the mechanical water heater control 100. The fastener holes 124 of the thermal insulator 120 are configured in a pattern such that the holes 124 match or align with the corresponding fastener holes 136 and 140 in the body 104 and flange 108, respectively.

The thermal insulator 120 also includes openings or open portions 128. One of the holes 128 in the insulator 120 allows the upper portion or top of the valve actuation or “pusher” disk 144 to contact the pivot operator on the other side of the insulator 120. In operation, the “pusher” disk 144 acts to open or close the valve by applying pressure to a snap spring, which “snaps” the valve open or closed to avoid a walk open valve actuation. The pusher disk 144 is acted upon by the pivot 145, which is operated by the rod 146 within the tube 112. The rod 146 may typically be formed from invar (which has a very low coefficient of thermal expansion), and the tube 112 may typically be formed from copper (which has a high coefficient of thermal expansion). The tube 112 may thus change length quite noticeably with temperature changes of the water while the rod 146 does not change length, thereby operating the mechanism.

In addition, wires in the tube 112 of the mechanical control 100 may be connected to a fuse within the tube 112. If the water temperature exceeds a certain high limit, the fuse opens. Since the fuse is in the millivolt circuit which powers the mechanical safety valve, the safety valve drops out (closes) which also shuts off the pilot, which is heating the millivolt generator. Thus, both the pilot and main burners are disabled, and the over-temperature situation is abated. The wiring for the fuse enters through an opening in the side of the base of the flange 108.

The holes 128 are configured to enable the three interactive points that exist for normal operation of the valve mechanism. The rod 146 in the tube 112 pushes on a point which is offset from a second point (the pivot). The first two points are referenced by a third point, which is an adjustment screw attached to a dial on the front of the control 100. These three points act in relation to one another to operate the valve (open or close) as a function of the temperature of the water. The three holes 128 enable the mechanism to operate normally. Advantageously, the openings 124, 128 of the thermal insulator 120 thus allow the insulator 120 to be retrofitted to the mechanical water heater control 100 without interfering with the normal operations of the control 100 and without requiring modifications to the control 100.

A wide range of thermally insulating materials may be used for the thermal insulator 120, which preferably have a thermal conductivity of less than 16 Watts per meter Kelvin (W/mK) and/or a Young's module of at least 200000. The thermal insulator 120 is preferably made of a material(s) having a thermal conductivity significantly lower than the thermal conductivity of the material(s) of the flange 108 (e.g., brass, etc.) and body 104 (e.g., aluminum, etc.). In which case, the thermal insulator 120 may then define or serve as a thermal break, thermal isolation gasket, or thermally insulative barrier between the thermally conductive flange 108 and body 104, thereby reducing the amount of heat conducted into the body 104. The thermal insulator 120 thus disrupts and inhibits the transfer of heat along what is traditionally an efficient heat path from the hot water in the storage tank through the flange 108 to the body 104 of the control 100.

In an exemplary embodiment, the thermal insulator 120 is made from stainless steel (e.g., plate made of type 301 stainless steel full hard having a thickness of about .01 inches, etc.). Stainless steel is a poor conductor of heat and has a lower thermal conductivity than many other metals, including aluminum, brass, and copper. Alternative embodiments may include a thermal insulator made from other suitable thermally insulating materials besides stainless steel, which materials are sufficiently rigid and stiff to meet the rigidity and stiffness requirements of an actuator system in a mechanical control.

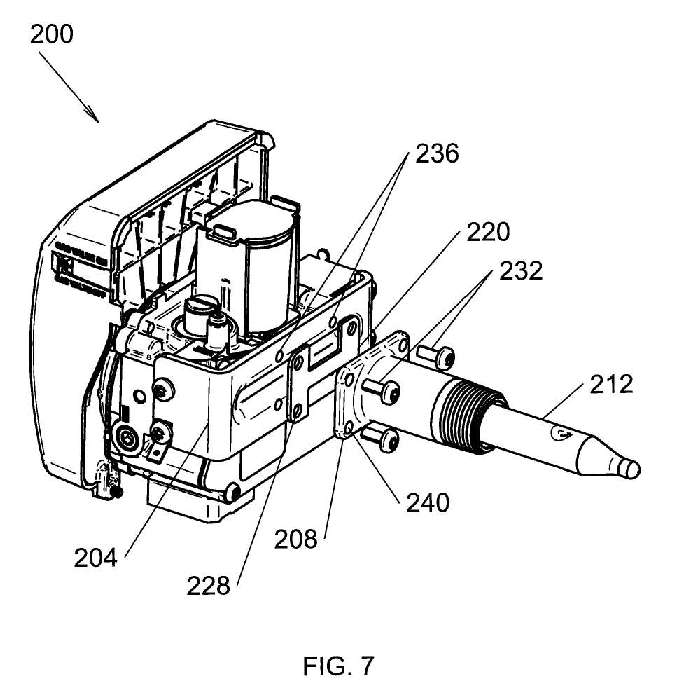

In some exemplary embodiments, the bolts or fasteners 132 are used to connect the flange 108 directly to the body 104. In other exemplary embodiments (e.g., FIG. 7, etc.), bolts or fasteners may be used to a connect a flange to a bracket, which, in turn, is connected to a body. The bolts or fasteners 132 may be made of a material having a relatively low thermal conductivity, such as less than 16 Watts per meter Kelvin (W/mK). In addition, some exemplary embodiments may also include washers on the fasteners 132, which washers may be made of a material having a relatively low thermal conductivity (e.g., 16 Watts per meter Kelvin, etc.) to help further reduce heat transfer from the flange 108 to the body 104. The washers may be made from the same material as the thermal insulator 120, such as stainless steel, a circuit board material (e.g., flame retardant 4 (FR-4) circuit board material, etc.), G-10 phenolic sheet material, or other suitable thermally insulating materials.

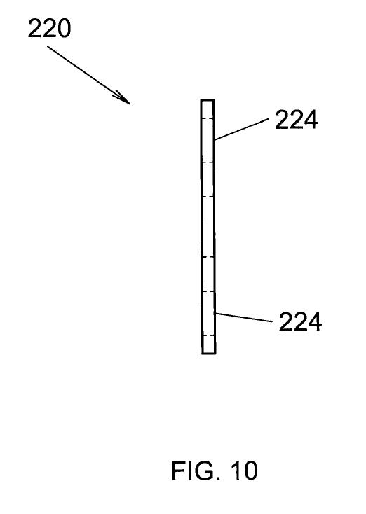

FIGS. 7 through 10 illustrate an exemplary embodiment of a thermal insulator 220 embodying one or more aspects of the present disclosure. As shown in FIGS. 7 and 8, the thermal insulator 220 is configured for placement between a flange 208 and a bracket 204, which is coupled (e.g., mechanically fastened, etc.) to the body of the electronic gas water heater control 200. FIG. 8 illustrates the mechanical water heater control 200 coupled to a wall 209 of a hot water tank and with the tube 212 extending into the hot water.

The thermal insulator 220 is shaped (e.g., shaped similar to the letter H of the English alphabet, etc.), sized, and provided with fastener holes 224 such that the thermal insulator 220 may be mechanically fastened with bolts 232 or other suitable fasteners between the flange 208 and the bracket 204 coupled to the body of the electronic gas water heater control 200. The fastener holes 224 of the thermal insulator 220 are configured in a pattern such that the holes 224 match or align with the corresponding fastener holes 236 and 240 in the bracket 204 and flange 208, respectively.

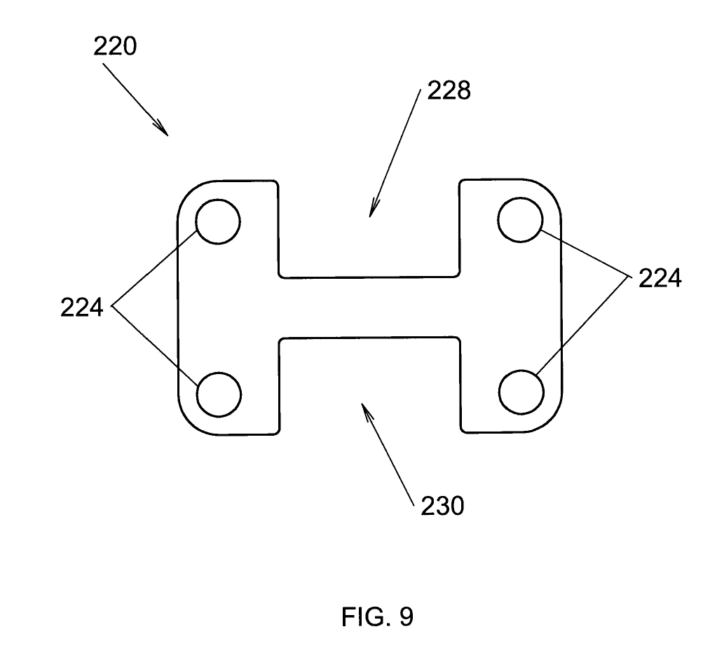

The thermal insulator 220 also includes upper and lower open portions or openings 228, 230 (FIG. 9). These open portions 228, 230 are configured (e.g., shaped, sized, located, etc.) so as to allow wiring (e.g., one or more wires, etc.) connected to the thermistor in the tube 212 to pass though the openings 228, 230 and be connected to the electronic control 200 via a connector located along the bottom edge of the control housing. Advantageously, the open portions 228, 230 and connector allow the thermistor to be unplugged from the control 200, so that the control 200 can be replaced in the field without having to drain the water heater as the flange 208 and tube 212 remain in place. The control 200 is preferably designed such that the circuit board is mounted to the cover such that when the cover is removed it can be replaced by a cover having a new circuit board. The openings 224, 228, 230 of the thermal insulator 220 allow the insulator 220 to be retrofitted to the electronic water heater control 200 without interfering with the normal operations of the control 200 and without requiring modifications to the control 200.

A wide range of thermally insulating materials may be used for the thermal insulator 220, which preferably have a thermal conductivity of less than 16 Watts per meter Kelvin (W/mK) and/or a Young's module of at least 200000. The thermal insulator 220 is preferably made of a material(s) having a thermal conductivity significantly lower than the thermal conductivity of the material(s) of the flange 208 (e.g., brass, etc.), bracket 204, and body (e.g., aluminum, etc.). In which case, the thermal insulator 220 may then define or serve as a thermal break or thermally insulative barrier between the thermally conductive flange 208 and bracket 204, thereby reducing the amount of heat conducted into the body. The thermal insulator 220 thus disrupts and inhibits the transfer of heat along what is traditionally an efficient heat path from the hot water in the storage tank through the flange 208 and bracket 204 to the body of the control 200.

In an exemplary embodiment, the thermal insulator 220 is made from Flame Retardant 4 or FR-4 circuit board material. In another example embodiment, the thermal insulator 220 is made of stainless steel. In a further example embodiment, the thermal insulator 220 is made of glass fiber reinforced nylon 6,6. In yet a further embodiment, the thermal insulator 220 is made of composite G-10/FR-4 glass epoxy laminate and/or a material having a thickness of about 0.020 inches, less than 2 percent water absorption, a thermal conductivity of about 0.27 Watts per meter Kelvin, and a compression strength of greater than or equal to 30 kips per square inch (ksi). Alternative embodiments may include a thermal insulator made from other suitable thermally insulating materials besides FR-4, G-10, glass epoxy laminates, stainless steel, or glass fiber reinforced nylon.

In some exemplary embodiments, the bolts or fasteners 232 are used to connect the flange 208 to the body via a bracket 204. The bolts or fasteners 232 may be made of a material having a relatively low thermal conductivity, such as less than 16 Watts per meter Kelvin (W/mK). In addition, some exemplary embodiments may also include washers on the fasteners 232, which washers may be made of a material having a relatively low thermal conductivity (e.g., 16 Watts per meter Kelvin, etc.) to help further reduce heat transfer from the flange 208 through the bracket 204 and to the body. The washers may be made from the same material as the thermal insulator 220, such as stainless steel, a circuit board material (e.g., flame retardant 4 (FR-4) circuit board material, etc.), G-10 phenolic sheet material, or other suitable thermally insulating materials.

By way of example only, exemplary embodiments including the thermal insulators disclosed herein (e.g., thermal insulator 120 (FIGS. 2-5), thermal insulator 220 (FIGS. 7-10), etc.) may provide or be associated with one or more of the following advantages. For example, the thermal insulators may be operable to eliminate or at least reduce the amount a water heater control overshoots a target temperature, thereby improving temperature calibration accuracy of the water heater control. The thermal insulators are not readily removable as they are mechanically fastened between the control's flange and body, and thus cannot be lost. The thermal insulators are protected from damage when located or placed between the control's flange and body. The thermal insulators do not prevent or restrict access to the gas valves. The thermal insulators are operable for largely preventing heat from reaching the gas valves, such that very little heat will be conducted away by the incoming gas lines, the gas itself as well as the outlet and pilot tubing. The thermal insulators may be retroactively added to existing gas water heater controls at lower costs than adding insulated covers over the gas valves. The thermal insulators are operable for thermally isolating the valve body, thereby reducing the thermal effects of the valve's thermal mass and heat sink effects.

To determine the effects that the inventors' insulators have when installed between a flange and body of a control on temperature calibration accuracy, DOE stacking tests were performed on a 37C73U-836 mechanical water heater control with and without a stainless insulator. Notably, the control without the insulator (standard production) overshot the target temperature by 14° F. But the control with the insulator overshot the target temperature by 6.6° F. Thus, the stainless steel insulator significantly decreased the amount by which the control overshot the target temperature. In other exemplary embodiments, a thicker stainless steel insulator or other thermal insulator (e.g., thickness greater than or equal to about 0.020 inches, etc.) may be used that is operable to eliminate or reduce (e.g., less than 6.6° F., etc.) the amount the water heater control overshoots a target temperature. These testing results are provided to further illustrate aspects of the present disclosure as they do not limit this disclosure to only configurations that can achieve these particular test results.

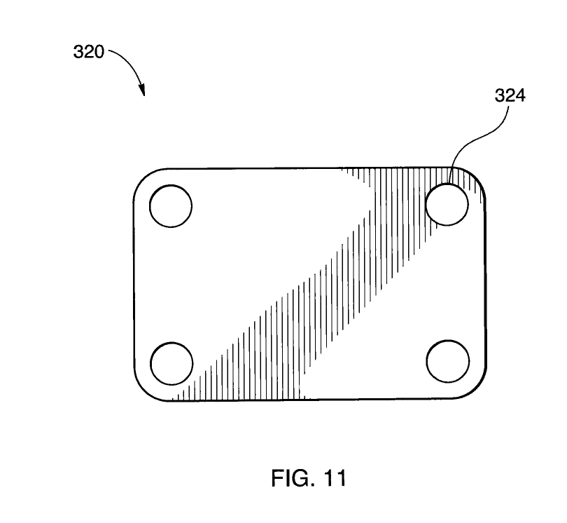

Additional testing was also performed on the exemplary embodiment of a thermal insulator or gasket 320 shown in FIG. 11 embodying one or more aspects of the present disclosure. The thermal insulator 320 is configured for placement between the body and flange of a water heater control. The thermal insulator 320 includes fastener holes 324 such that the thermal insulator 320 may be mechanically fastened with bolts, screws or other suitable fasteners between the body and flange of a water heater control. The fastener holes 324 of the thermal insulator 320 are configured in a pattern such that the holes 324 match or align with the corresponding fastener holes in the body and flange.

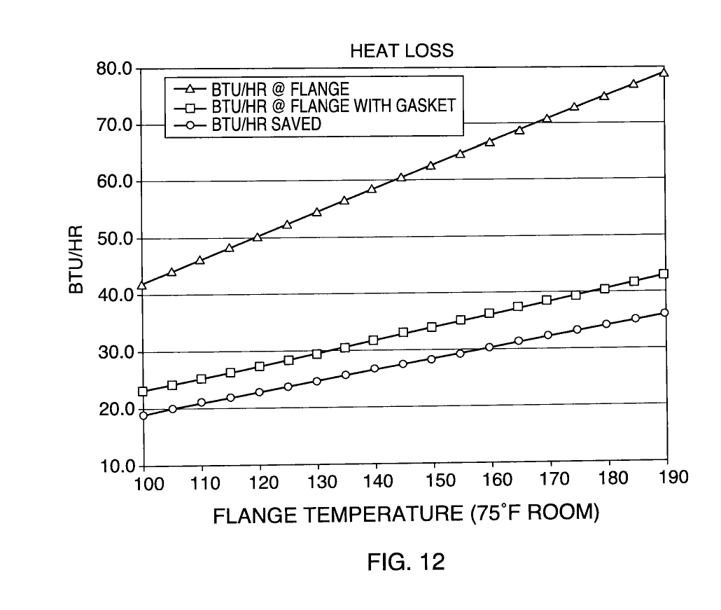

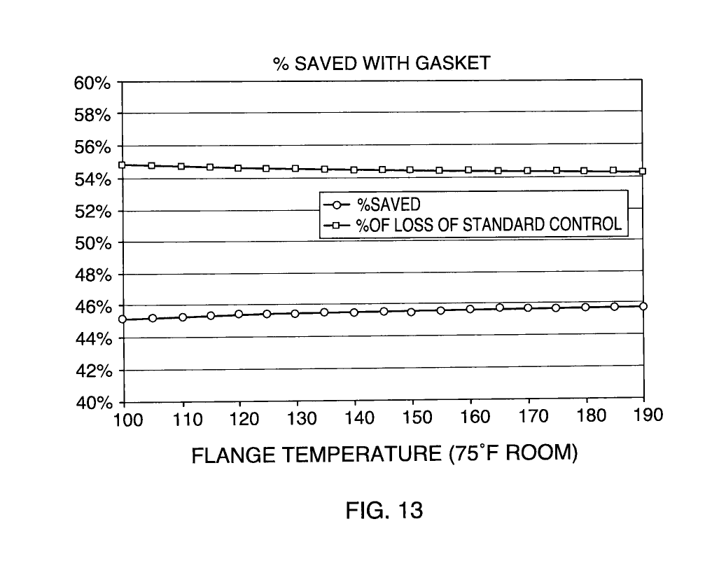

For this particular testing, the thermal insulator or gasket 320 was formed from a FR-4, G-10 phenolic sheet having a thickness of about 0.021 inches and having a thermal conductivity of about 0.27 Watts per meter Kelvin (W/mK). FIG. 12 is an exemplary line graph illustrating heat loss in British thermal units per hour (BTU/HR) versus flange temperature in degrees Fahrenheit (° F.). FIG. 13 is an exemplary line graph illustrating percentage of heat loss versus flange temperature in degrees Fahrenheit. Generally, FIGS. 12 and 13 show that adding the thermal insulator 320 markedly reduces the heat transfer and heat loss from the water heater through the control. For example, at 120° F. flange temperature, the addition of the thermal insulator 320 saves over 20 BTU/hour of loss from the valve. It was also observed that there is greater than a forty-five percent reduction in heat dissipation from the valve, and that the control was over 20° F. degrees cooler at a 140° F. flange temperature.

Heat transfer from a water heater through a control is a significant portion of the heater's energy loss. By adding the thermal insulator 320, the percentage of heat loss through the control may be reduced (e.g., from about 6.8 percent down to 3.9 percent, etc.). Typically, the valve temperature is the average of the tank temperature and the room temperature. Based on the valve's approximately 2.5 percent contribution to standby loss, adding a thermal insulator should represent about one percent overall energy savings for the hot water tank in standby mode.

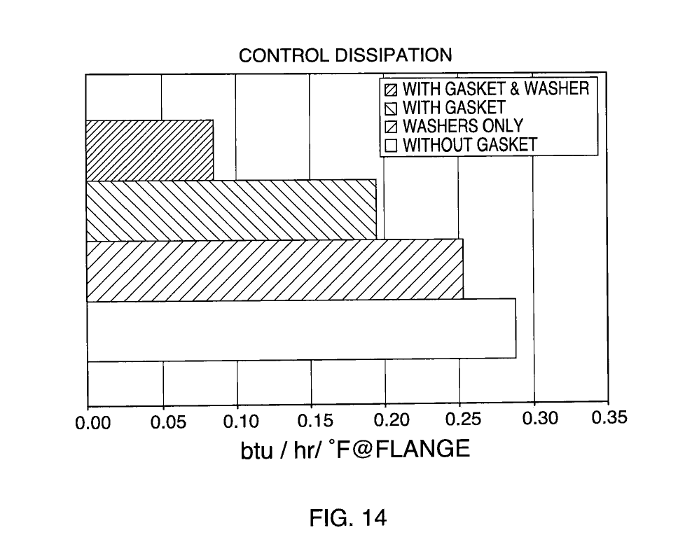

In addition, FIG. 14 is an exemplary bar graph showing heat dissipation in British thermal units per hour per degrees Fahrenheit (BTU/HR/° F.) at the flange. Generally, FIG. 14 shows that adding the thermal insulator or gasket 320 markedly reduces the heat transfer and heat loss from the water heater through the control. FIG. 14 also shows that a further reduction in heat transfer and heat loss may be realized by adding thermally insulative washers on the flange screws. In this example, the washers were made from the same material (FR-4, G-10 phenolic sheet having a thickness of about 0.021 inches) as the thermal insulator 320. Alternative embodiments may include washers made from other suitable thermally insulating materials.

These testing results shown in FIGS. 12, 13, and 14 are provided only to illustrate aspects of the present disclosure as they do not limit this disclosure to a particular configuration that can achieve the particular test results.

FIGS. 1 and 6 respectively illustrate a mechanical control 100 and an electronic control 200 to which thermal insulation may be added, provided, applied, disposed, etc. between the body 104, 204 and flange 108, 208 as shown in FIGS. 2 and 7, respectively. But the controls 100, 200 are examples only as the present disclosure is not limited to use with any particular control, controller, or control system for gas water heaters. Instead, various exemplary embodiments of the present disclosure may be used with a wide range of gas water heater controls, valves, water heaters, etc.

It should also be noted that although various exemplary embodiments are described with reference to gas water heaters, exemplary embodiments may also be used with other controllers, controls, and control systems for other types of fluid heaters and/or devices. For example, exemplary embodiments may be used in conjunction with electric heaters for water and other fluids.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials may be used, etc.) and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A valve assembly for a water heater, comprising:
a flange configured to be coupled to a storage tank of the water heater;
a body configured to be coupled to the flange; and
a thermal insulator configured for placement generally between the flange and a body of the valve assembly, the thermal insulator having a lower thermal conductivity than the flange and the body, whereby the thermal insulator is operable for inhibiting heat loss from within the storage tank through the valve assembly.

2. The valve assembly of claim 1, wherein:
the thermal insulator includes one or more fastener holes alignable with corresponding fasteners holes of the flange and the body; and
the thermal insulator is coupled to the flange and the body by one or more mechanical fasteners within the aligned one or more fastener holes.

3. The valve assembly of claim 1, wherein:
the thermal insulator includes one or more openings for allowing wiring connected to a temperature sensing device coupled to the flange and extending into the storage tank to pass through the one or more openings, or for allowing a portion of a valve actuation disk on one side of the thermal insulator to contact a pivot operator on an opposite side of the thermal insulator; and/or
the thermal insulator has a thermal conductivity less than 16 Watts per meter Kelvin and/or a Young's modulus of at least 200000.

4. The valve assembly of claim 1, wherein:
the flange is coupled to a storage tank; and
the thermal insulator is disposed along a heat path defined from within the storage tank through the flange and the thermal insulator to the body.

5. The valve assembly of claim 4, further comprising a temperature sensing device coupled to the flange and extending into the storage tank, whereby the thermal insulator defines a thermal break or thermally insulative barrier along the heat path from the temperature sensing device through the flange to the body thereby reducing heat transfer from within the storage tank.

6. The valve assembly of claim 5, wherein:
the flange comprises a brass flange having a threaded internal portion and a threaded external portion that is threaded into a threaded hole in the storage tank;
the body comprises an aluminum body to which the brass flange is mechanically fastened;
the temperature sensing device comprises a copper tube threaded to the threaded internal portion of the flange; and
the thermal insulator comprises stainless steel or FR-4 circuit board material.

7. A water heater comprising a storage tank and the valve assembly of claim 1, wherein the flange is coupled to the storage tank, and wherein:
the body is coupled to the flange with the thermal insulator therebetween; or the flange is coupled to a bracket that is coupled to the body, such that the thermal insulator is generally between the bracket and the flange.

8. A water heater of claim 7, further comprising a control including the valve assembly and operable for controlling fuel flow.

9. The water heater of claim 8, wherein the control comprises a mechanical control or electronic control.

10. A valve assembly for adjusting fuel flow in a fuel-fired water heater having a storage tank, the valve assembly comprising:
a thermal insulator;
a first component configured to be coupled to the storage tank;
a second component coupled to the first component with the thermal insulator generally between the first and second components; and
a third component coupled to the first component, the third component configured to extend at least partially into the storage tank for sensing temperature of water within the storage tank when the first component is coupled to the storage tank;
wherein the thermal insulator has a lower thermal conductivity than the first, second, and third components for inhibiting heat loss from within the water storage tank through the valve assembly.

11. The valve assembly of claim 10, wherein:
the thermal insulator includes one or more fastener holes alignable with corresponding fasteners holes of the first and second component; and
the thermal insulator is coupled to the first and second components by one or more mechanical fasteners within the aligned one or more fastener holes.

12. The valve assembly of claim 10, wherein:
the thermal insulator includes one or more openings configured to allow passage of wiring connected to the third component and/or to allow contact between portions of components of the valve assembly that are on opposite sides of the thermal insulator; and/or
the thermal insulator has a thermal conductivity less than 16 Watts per meter Kelvin and/or a Young's modulus of at least 200000.

13. The valve assembly of claim 10, wherein:
the first component comprises a brass flange;
the second component comprises an aluminum body or a bracket;
the third component comprises a copper tube; and
the thermal insulator comprises stainless steel or FR-4 circuit board material.

14. A water heater comprising a storage tank and the valve assembly of claim 10, wherein:
the first component is coupled to the storage tank; and
the third component extends at least partially into the storage tank and is operable for sensing temperature of water within the storage tank.

15. The water heater of claim 14, further comprising a control including the valve assembly and operable for controlling fuel flow.

16. The water heater of claim 15, wherein the control comprises a mechanical control or electronic control.

17. A method for inhibiting heat loss from a storage tank of a water heater through a valve assembly of the water heater, the method comprising positioning a thermal insulator generally between a body and a flange of the valve assembly, wherein the thermal insulator has a thermal conductivity less than a thermal conductivity of the flange and the body.

18. The method of claim 17, wherein the thermal insulator defines a thermal break or thermally insulative barrier along a heat path from within the storage tank through the flange and the thermal insulator to the body thereby reducing heat transfer from within the storage tank.

19. The method of claim 17, wherein:
the thermal insulator includes one or more fastener holes alignable with corresponding fasteners holes of the flange and the body; and
the method includes:
positioning the thermal insulator relative to the body and the flange to align the one or more fastener holes; and
coupling the thermal insulator to the flange and the body by using one or more mechanical fasteners positioned within the aligned one or more fastener holes.

20. The method of claim 17, wherein:
the thermal insulator includes one or more openings; and
the method includes positioning the thermal insulator relative to the body and the flange such that:
wiring connected to a temperature sensing device coupled to the flange passes through the one or more openings of the thermal insulator; or
portions of components of the valve assembly that are on opposite sides of the thermal insulator are able to make contact through the one or more openings.
